(19) United States
(12) Patent Application Publication
(10) Pub. No.: US 2008/0098134 A1
(43) Pub. Date: Apr. 24, 2008

(54) Portable Storage Device and Method For Exchanging Data

(75) Inventors: Victor Martinus Van Acht, St. Oedenrode (NL); Martinus Wilhelmus Blum, Eindhoven (NL); Nicolas Lambert, Waalre (NL); Pierre Hermanus Woerlee, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,513

(22) PCT Filed: Aug. 31, 2005
(86) PCT No.: PCT/IB05/52849

§ 371 Date: Mar. 1, 2007

(30) Foreign Application Priority Data
Sep. 6, 2004 (EP) 04104277.1

(51) Int. Cl. G06F 13/18

(52) U.S. Cl. 710/33

(57) ABSTRACT

A portable storage device (MC) is disclosed, which comprises a memory (MEM) for storing data (DAT), a data interface (INT) for exchanging data (DAT) between the memory (MEM) and a host device (DEV), radio communication interface (RI) designed for receiving a key (K) from a transponder (T), checking means (COMP) for checking if a key (K) has a predefined value (V, and access inhibit means (SW) for controlling access to the memory (MEM), wherein the access inhibit means (SW) are controlled by the checking means (COMP). Access to the memory (MEM) is only granted if a certain key (K) can be received, which means that a certain transponder (T) has to be in the vicinity of the portable storage device (MC) for granting access. Furthermore, data (DAT) which is transferred from host device (DEV) to memory (MEM) can be encrypted and data (DAT) which is transferred from memory (MEM) to host device (DEV) can be decrypted. In this way for example commonly used memory cards can be secured against unauthorized use.

### FIELD OF THE INVENTION

The invention relates to a storage device which comprises a memory for storing data, and a data interface comprising electric contacts for exchanging data between the memory and a host device via electric signals.

The invention furthermore relates to a method for exchanging data between a portable storage device and a host device wherein the portable storage device is connected to the host device via electric contacts or a radio link.

Finally, the invention relates to a transponder, a mobile device, and a digital camera to implement the inventive method.

### BACKGROUND OF THE INVENTION

Due to the increasing use of digital devices also the need for digital storage devices is still increasing. Examples for digital storage devices of such kind are solid-state memories such as compact flash cards, secure digital / multimedia cards, smart media cards, memory sticks, picture cards, and hard disks such as the so-called “microdrives” as well as USB-sticks and the like. Such storage devices are used in digital cameras, personal digital assistants and MP3 music players for instance. So it is easy to understand that such storage devices often contain private or confidential data.

Some cards have securing mechanisms to prevent unwanted overwriting of data. An example for such a copy protection is a switch on a secure digital multimedia card. This type of card also comprises an additional feature which provides a copy protection for copyright protected data such as music. So reading data is allowed at any time, writing only if the switch is in the right position. Since a switch is not really a barrier against unauthorized access, data on those storage devices is more or less unsecured.

In addition, some USB-sticks are password protected so that after sticking the memory stick into a computer a predefined password has to be entered before data can be exchanged between the computer and the USB-stick. Usually this password is entered on the keyboard of the computer which leads to a security problem since attacks to computers through the internet are regrettably very common in our days. So it is risky to enter passwords via a keyboard of a computer which could potentially been spied out. While password protection is risky for computers it could be a proper method for digital cameras since they are usually not connected to a network. However, a common digital camera lacks adequate input means, so that protection of private data is not possible also through a password either.

Further methods for securing data are known from the prior art published in patent literature. One example is US 2004/0054594, “RFID security device for optical disc”, dated Mar. 18, 2004 which discloses an optical disc having a security feature in the form of an RFID tag that communicates with a voltage controlled optical modifier layer in the optical disc. In the presence of an interrogation signal, the RFID tag allows the optical disc to be used normally by outputting a voltage to the optical modifier layer. In the absence of an interrogation signal, the optical modifier layer prevents a laser from reading from or writing on the optical disc.

U.S. Pat. No. 6,717,507, “Radio frequency tags for media access and control”, dated Apr. 6, 2004 also discloses a system, which provides access and moreover control of electronic media such as a CD wherein again RFID tags have a memory programmed to access a particular media source when polled by an RF transceiver connected to a media player. The user authorization is not performed on the CD itself as it is the case in US 2004/0054594, but in the media player. RFID tags here are only for storing access or control information.

US 2004/0029563, “Method and system for controlling access”, dated Feb. 12, 2004 furthermore discloses a method to provide access to a PC or a mobile phone wherein the PC or the mobile phone comprises a short-range radio transmission/receiving module with a certain first coverage area. Additionally, there is a short-range radio transmission/receiving device with a certain second coverage area. If both coverage areas overlap, an identification message is sent from the short-range radio transmission/receiving device to the PC or the mobile phone. Subsequently, the identification message is checked to determine whether the identifier provides authorization to enable use of the functions of the PC or the mobile phone.

US 2003/0005300, “Method and system to maintain portable computer data secure and authentication token for use therein”, dated Jan. 2, 2003 discloses a similar system. Here a laptop disk is encrypted and each time data is fetched from the disk the laptop sends a short message requesting a decryption key from an authentication token worn or associated with the proper laptop user. If the user and his/her token are present, then access is allowed. If they are not present, then access is disallowed and all in-memory data is flushed to the disk. The user wears the small authentication token that communicates with the laptop over a short-range wireless link.

U.S. Pat. No. 6,515,575, “Method of authenticating a user and system for authenticating user”, dated Feb. 4, 2003 discloses a further similar system wherein a portable data communication terminal is allowed to carry out a certain operation only when a user authenticating device can be detected within a radio coverage area of the portable data communication terminal. So it is possible to prevent a third party from using the portable data-communication terminal without permission of the user.

Lastly, US 2001/0006902, “IC card with radio interface function, antenna module and data processing apparatus using the IC card”, dated Jul. 5, 2001 discloses an additional feature for a secure digital memory card, SD memory card for short. The SD memory card contains an RF circuit, a controller and a flash memory. The RF circuit is connected to an antenna module attached to the SD memory card. The controller executes radio interface control and interface control for the SD memory card. Thus the SD memory card can serve as a modem analog to the well known PCMCIA modem functionality.

### OBJECT AND SUMMARY OF THE INVENTION

As stated before, the prior art lacks an easy but still secure possibility to prevent unauthorized access to data on portable storage devices. The problem of the invention is therefore to specify a portable storage device that is capable of preventing unauthorized access.

The inventive problem is solved by a portable storage device of the aforesaid kind, further comprising a radio communication interface designed for receiving a key, checking means for checking whether a key has a predefined value, and access inhibit means for controlling access to the memory wherein the access inhibit means are controlled by the checking means.

As stated, the storage device expects a key for granting access. Therefore, a request for transmitting a key is broadcast before access is granted. This can happen when the portable storage device is connected to the host device respectively powered, or at the time when access is requested, from the host device for example. Preferably this key is stored on a transponder such as a smart card (keycard) or on a mobile phone or a personal digital assistant (PDA). But also other devices are imaginable, which are capable of transmitting a key to the portable storage device. Based on said request the key is now sent to the portable storage device where it is compared to a stored key. If there is a match access is granted through access inhibit means, otherwise it is not. It should further be mentioned that the key could also be transmitted from transponder or mobile device on a regular basis without a special request from the portable storage device.

There are a couple of possible solutions to design access inhibit means. One is a switchable connection on the data path between host device and memory. There can be real switches between data interface and memory as well as inhibit inputs for the memory or the interface which are controlled by the checking means. It should be mentioned that the dividing into separate modules as switch, interface, comparator and so on is not necessary for the invention. Rather any combination of the modules is possible, so that the different modules have a more functional meaning. For example it is possible that comparator, access inhibit means as well as data interface are integrated into a device controller.

A further possibility for access inhibit means is a switchable power source for the memory or other relevant parts of the storage device such as the data interface. Powering down the memory or relevant parts of the storage device combines two benefits, first denying access and second saving energy. This can be comparatively important because host devices such as digital cameras, PDAs, mobile phones and so on are usually battery powered.

It is also possible that access inhibit means are in the form of default data which is transferred to the host device when access is denied. Such default data can be a default file system, default text, default picture or encrypted data. For example default data can comprise a file system with the two files “readme.txt” and “seeme.jpg” which both contain the information that access is denied. Thus seeme.jpg can be displayed on a monitor of a digital camera in this case.

Advantageously, a host device has not necessarily to be redesigned to work together with an inventive storage device. In fact it is possible for example to use an inventive memory card in combination with a standard digital camera or an inventive USB-stick in combination with a standard computer. Hence securing data can be provided in combination with prior art host devices, which increases user acceptance.

A preferred embodiment of the invention is also given with a portable storage further comprising encrypting means for encrypting data which is transferred from host device to memory, and decrypting means for decrypting data which is transferred from memory to host device. In this case data on the portable storage device is encrypted so that is quite impossible for intruders to get useful information without having a proper key. So data is encrypted when it is written to the memory of the storage device and decrypted when it is transferred to a host device. For encryption there are basically two possibilities, symmetric-key encryption and asymmetric-key encryption.

With symmetric-key encryption, the encryption key can be calculated from the decryption key and vice versa. Most symmetric algorithms moreover use the same key for encryption and decryption. Implementations of symmetric-key encryption can be highly efficient, so that users do not experience any significant time delay as a result of the encryption and decryption. Symmetric-key encryption is effective only if the symmetric key is kept secret by the two parties involved. If anyone else discovers the key data is not secure any longer.

Asymmetric-key encryption (also called public-key encryption) involves a pair of keys: a public key and a private key, wherein the public key is published and the corresponding private key is kept secret by the user. Data encrypted with a public key can be decrypted only with a corresponding private key. Compared with symmetric-key encryption, public-key encryption requires more computation.

The key to unlock the portable storage device and the key for ciphering are not necessarily the same. Usually a second key would be used for this reason, which second key is preferably stored in the transponder or the mobile device and can be transferred to the storage device together with the first key or in a separate procedure. If the second key is stored in the transponder or in the mobile device, it can easily be accessed without burdening the user who has simply to hold the keycard within the vicinity of the host device. But of course it is also possible to enter the key via input means on the host device. In case of symmetric-key encryption, the second key is the symmetric key, in case of asymmetric-key encryption, the second key is the private key. The public key can be stored in the portable storage device or in the host device since it is not secret. The advantage of the asymmetric-key encryption is that encrypted data can also be stored in the portable storage device without having a keycard.

It is also possible that different files are encrypted with different keys, which keys (symmetric-key encryption) or pairs of keys (asymmetric-key encryption) can be associated with different users. In this way a portable storage device can be used by different users without damaging the privacy of each user. If the second key cannot be received in the portable storage device, it is possible to simply display encrypted data to the host device. So the decision what to do is shifted to the host device respectively to the user who will probably interpret encrypted data as a failed attempt to access the storage device.

A further preferred embodiment of the invention is given when a data interface is omitted and said radio communication interface is additionally arranged for exchanging data between memory and host device by radio instead. In this case the communication between portable storage device and host device takes place via the radio communication interface. That is why a separate data interface with electric contacts can be omitted, so that the complexity of the storage device is decreased. Furthermore, contactless data transfer is provided which increases the ease of use.

It is further advantageous, when memory, radio communication interface, checking means, access inhibit means as well as the optional data interface are included in a single chip. The integration of all or at least relevant parts of the portable storage device into a single chip reduces the possibilities for unauthorized use. If there are separate parts for memory and access inhibit means, an intruder could solder a memory chip out of the storage device and solder it into a storage device that has no securing mechanism for example. In this way he can use private data without authorization.

It is also preferred, when radio communication interface or data interface is arranged for receiving an access level which is to define different access rights to the memory for different access operations and/or to define different access rights for different parts of the memory, wherein said portable storage device furthermore comprises means for storing said access level. This embodiment provides the possibility to grant different access rights such as for reading, writing, changing, or deleting data respectively for executing the code. In this way a file which is worth keeping but which is not really private can be marked for reading for example. So any user can read this data but he cannot change or delete it. In particular this is useful if more users share a single storage device. It is possible to attach each file with separate access rights or the whole memory or at least parts of the memory, for example a partition or a directory.

Preferably, the storage device furthermore comprises means to set said access level. This means can be buttons, wheels and the like. It is needless to say that changing an access level should only be possible if the keycard is in the vicinity of the storage device. So writing to the access level storage means is only enabled when the result of the checking means is true.

The inventive problem is also solved by a method of the aforesaid kind further comprising the step of permitting access to the memory through said electric contacts or said radio link if a predefined key can be received from a transponder or a mobile device. It is noted here that advantages and preferred embodiments of the inventive storage device are also applicable to the inventive method and vice versa. It is further noted that the steps of the method do not necessarily have to be processed in the aforesaid order. In fact access can be checked and permitted before a storage device is connected to a host device. To perform said steps a memory card could be “active” in this case, which means powered by a battery or a capacitor for example. But it is also imaginable for a mobile device with a proper radio interface (e.g. according to the standard for Near Field Communication) to power a passive memory card and transmit the necessary key.

In a preferred embodiment the electric or radio connection between portable storage device and host device is of such a kind that the portable storage device is powered through this connection. So there is no need for battery powered storage devices.

It is advantageous when data, which is transferred from host device to memory, is encrypted and data which is transferred from memory to host device is decrypted. As stated before, data encryption prevents a user from unauthorized access.

It is further advantageous when access is permitted until the portable storage device is disconnected from the host device once the key has been transmitted. In this case the enabling device which sends the key to the storage device not necessarily need be in the vicinity of the storage device for the whole time. The key is transmitted once and is valid until the storage device is pulled out of a host device and therefore powered down again or until the host device and therefore also the memory card is powered down (if there is no battery in the memory card). A key can also be valid for a predefined time, so that a portable storage device can be lent to another user without leaving him a keycard.

It is also advantageous when access for a running operation between host device and portable storage device is permitted until said operation has been finished. In this case it is periodically checked if the predetermined key can be received. But even if the keycard is not in the vicinity of the storage device any longer, a running operation between host device and storage device should not be disrupted. For example the keycard is removed while data is written from the host device to the storage device. If access would be denied immediately, data may be damaged if for example only a part of a file could be written onto the storage device. Thus control means have to be provided which ensure access grant until a running operation has been finished.

It is also advantageous if full access, which means for example reading and writing is provided until a certain operation has been finished. It may be required that a host device can still read from the memory to bring storage device and host device in a consistent state even if the requested operation was deleting a file for example.

Lastly it is advantageous, when an access level for at least part of the memory is received by the portable storage device over a radio communication interface or over an electric data interface and stored in said portable storage device. Portable storage devices usually do not have input means. Therefore, an access level can be received for example from the host device (e.g. a digital camera with input means) or the device which transmits the key (e.g. from a mobile device or a transponder with input means). Again setting of an access level should only be possible if the keycard or mobile phone respectively is in the vicinity of the storage device. It is further possible that part of the memory can be accessed at any time without providing a key. This features makes sharing a single storage device between a couple of users easier. It is also possible that read or write access is additionally possible at any time without providing a key, thus enabling a user to read data but not to change it for instance.

Finally, it is also advantageous, when a transponder, a mobile device, or a digital camera has means for inputting an access level, which access level is to define different access rights for different access operations to a memory of a portable storage device and/or to define different access rights for different parts of a memory of a portable storage device, wherein said portable storage device is designed for exchanging data with a host device, the transponder, the mobile device, or the digital camera further comprising means for transmitting said access level to said portable storage device by radio link.

Portable storage devices usually do not comprise input means, so that it is useful to use devices for inputting an access level which normally have these input means. In this way the technical complexity can be kept low for the portable storage device since no “hardware” in the form of buttons or displays for instance have to be introduced. In comparison, the technical effort to adapt a mobile phone or a PDA for example is comparatively low since there is more or less only a change of software.

### BRIEF DESCRIPTION OF THE DRAWINGS

The invention will now be explained in more detail with the help of the following examples and figures which comprise further advantages and embodiments of the invention and which may not serve to narrow the broad scope of the invention.

FIG. 1: shows an inventive system with a transponder storing the key.

FIG. 2: shows an inventive system with a mobile device storing the key.

FIG. 3: shows an inventive system wherein an electric data interface is omitted.

FIG. 4: shows a system as in FIG. 1 wherein access is inhibited through powering down the memory.

FIG. 5: shows a system as in FIG. 1 with additional encryption/decryption means and means for storing an access level.

### DESCRIPTION OF EMBODIMENTS

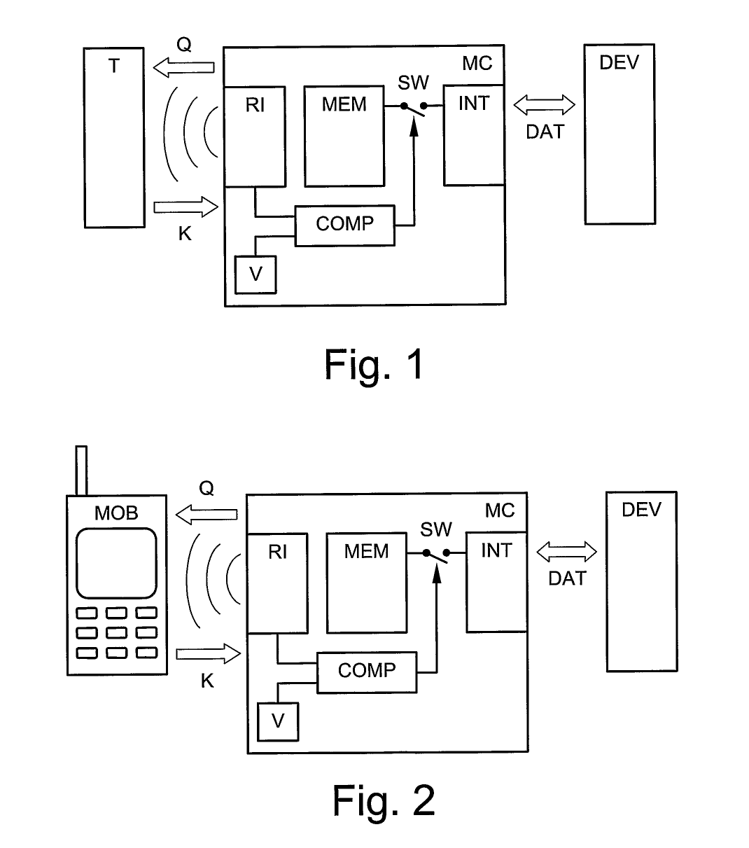

FIG. 1 shows a portable storage device MC, a transponder T and a host device DEV. The portable storage device MC comprises a memory MEM, a data interface INT, access inhibit means in the form of a switch SW, a radio communication interface RI, a register for storing a predefined value V for a key K and lastly checking means in the form of a comparator COMP. The comparator COMP has two inputs, one is connected to the radio communication interface RI, the other one to the register for the predefined value V. The output of the comparator COMP is further provided to control the switch SW. The function of the system of FIG. 1 is as follows.

First of all the portable storage device MC is plugged into a slot of the host device DEV thus providing electric connection between portable storage device MC and host device DEV. The portable storage device MC is now powered by the host device DEV. Subsequently, a user of the host device DEV requests that data DAT is transferred from portable storage device MC, which is still locked on to the host device DEV. Now a request Q for a key K is broadcast by the radio communications interface RI. The transponder T, being in the proximity of the portable storage device MC or defining it more precisely being in the radio range of the portable storage device MC, receives this request Q and answers this request Q with the key K, which is subsequently received by the radio communications interface RI of the portable storage device MC. After this, key K is compared with a predefined value V by the comparator COMP. If there is a match, comparator COMP activates its output, which causes the switch SW to be closed. Now access to the memory MEM is provided and data DAT can be transferred between the portable storage device MC and the host device DEV. If key K cannot be received, access is still denied. It is also possible that the request Q for a key K is already sent when the portable storage device MC is plugged into the host device DEV. It is also noted that the access inhibit means are not necessarily in the form of a switch SW between memory MEM and data interface INT as shown. In fact there could also be an inhibit input for the memory MEM or the data interface INT for example. It should farther be noted that comparator COMP is not necessarily a piece of hardware but can also be realized by means of software running in the processor of the storage device MC.

FIG. 2 shows the system of FIG. 1 wherein a mobile device MOB is substituted for the transponder T . Transponders T are usually but not necessarily passive, which means that they do not have their own power source but are powered by the electromagnetic field generated by the radio communication interface RI. Different from this, mobile devices MOB such as mobile phones or PDAs are active and can therefore provide a larger communication distance. A further advantage is that no separate transponder T is necessary since nearly everyone carries a mobile phone nowadays.

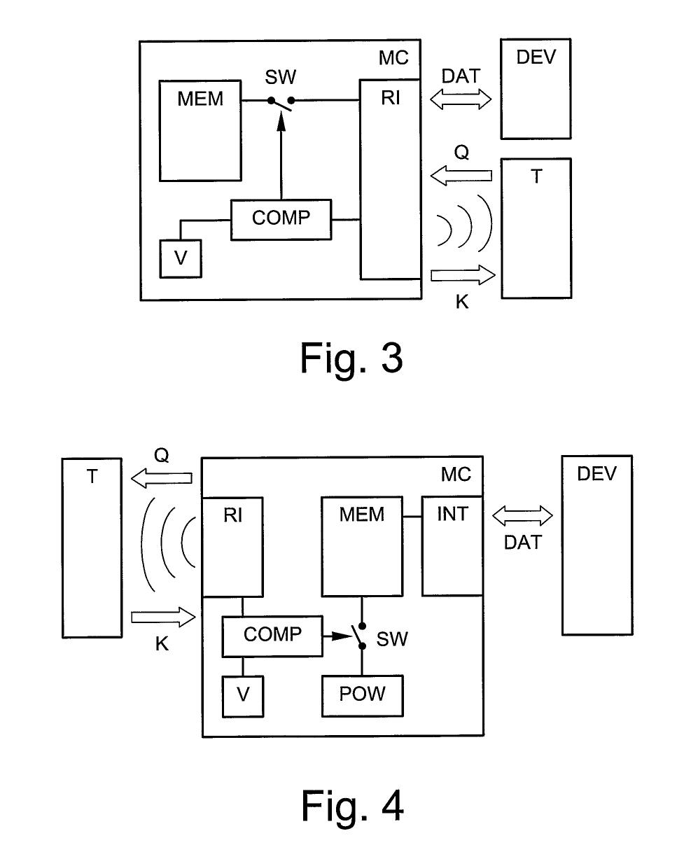

FIG. 3 shows the system of FIG. 1 wherein the data interface INT is omitted and the data communication between portable storage device MC and host device DEV is provided through the radio communication interface RI. So, additionally, data DAT is transmitted contactlessly between the portable storage device MC and the host device DEV, which increases user acceptance.

FIG. 4 further shows a system of FIG. 1 wherein the switch SW is not placed between memory MEM and data interface INT, but between memory MEM and a power source POW. If access is granted, the switch SW is closed thus powering the memory MEM. If access is denied, switch SW is open, which additionally saves energy. It should be noted that a power source POW may not only be an active power source in the portable storage device MC such as a battery or an accumulator, but can also be powered by the host device DEV. In this case power source POW may be seen as the electric interface INT or as a receiving coil of the portable storage device MC if energy is transmitted to the storage device MC inductively for instance.

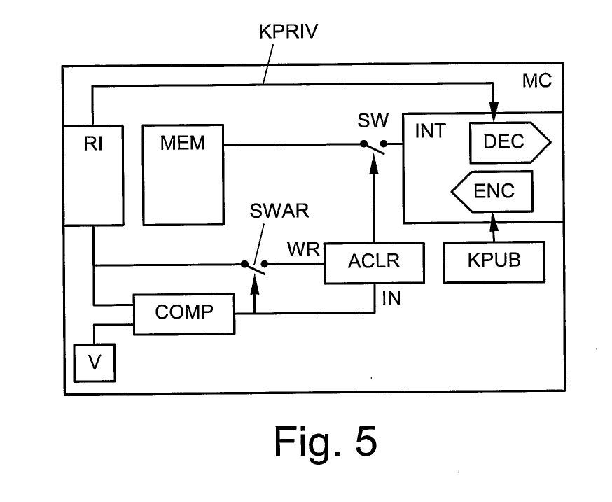

FIG. 5 lastly shows the system of FIG. 1, wherein encrypting means ENC and decrypting means DEC are integrated into the interface INT. The direction of the arrows shows the operation mode. Data DAT which is transferred from the host device DEV to the memory MEM is encrypted by the encrypting means ENC, data DAT which is transferred from the memory MEM to host device DEV is decrypted by the decrypting means DEC. Furthermore, access level storage means in the form of an access level register ACLR are introduced. Its input IN is connected to the output of the comparator COMP, its output connected to the switch SW. In this case comparator COMP does not directly control switch SW, but influences it via the access level register ACLR. Comparator COMP furthermore controls the switch SWAR, which is situated between the radio communication interface RI and the access level register ACLR and which enables or disables writing of the access level register ACLR through a write input WR of the access level register ACLR.

The function of the embodiment shown in FIG. 5 is explained by the use of an exemplary application of the invention. For this reason it is assumed that portable storage device MC is a memory stick, host device DEV a digital camera and mobile device MOB a mobile phone. This is only to illustrate the invention and shall not limit the broad scope of the invention.

First of all the user of the system sets the access level of the portable storage device MC. It is assumed that the mobile device MOB has capability to communicate according to the standard for near field communication, NFC for short. The NFC technology evolved from a combination of contactless identification, namely the RFID technology, and interconnection technologies. NFC operates in the 13.56 MHz frequency range, over a distance of typically a few centimeters, but in future also greater distances of up to 1 m might be possible. NFC technology is standardized in ISO 18092, ECMA 340 and ETSI TS 102 190. NFC is also compatible with the broadly established contactless smart card infrastructure based on ISO 14443.

It is further assumed that key K has been stored in the memory of the mobile device MOB. The user brings the portable storage device MC close to the mobile device MOB and activates a function for changing the access level of the portable storage device MC on the mobile device MOB. Subsequently, the mobile device MOB emits an electromagnetic field thus powering the portable storage device MC. Then portable storage device MC sends a request R to the mobile device MOB to transmit the key K. Mobile device MOB subsequently transmits the key K to the portable storage device MC, which key is compared to a predefined value V by a comparator COMP. It is assumed that the result of this check is true, thus activating the switch SWAR and thus enabling the rewriting of the access level register ACLR. Now the user enters the access level desired for the portable storage device MC on his mobile device MOB, which access level is transmitted to the radio communication interface RI and from there to the access level register ACLR and stored there. For instance the user has entered the following rights.

| | read | write | Delete | execute |
|---|---|---|---|---|
| with key | x | | | — |
| without key | | x | | — |

Reading will only be possible when the key K is present, thus avoiding unauthorized use of the pictures on the portable storage device MC, whereas writing will also be possible without key K thus providing a comfortable use of the digital camera DEV. So taking a picture is possible at any time. Deleting is forbidden irrespective of whether key K is present or not, thus avoiding unwanted deletion of data. So an unauthorized person could only write additional data DAT onto the memory card, but cannot access data DAT which has already been stored. The column “execute” is not relevant to this example since it is assumed that only pictures are stored in memory MEM for reasons of better understanding. So entering marks is inhibited for this column. It is also assumed that this setting relates to the whole storage device MC, but it is also imaginable that a setting only relates to a single file or a partition or a directory of memory MEM.

Now user takes away the mobile device MOB from the portable storage device MC, thus causing the opening of the switch SWAR and puts the storage device MC into the host device DEV. Subsequently, the storage device MC is powered through the electric contacts. He attempts to look at some pictures on the storage device MC, which is denied since mobile device MOB is not in the proximity of the storage device MC. Then he takes a picture and stores it onto the storage device MC. This is possible as writing is enabled even if key K is not present. The “zero” on the input IN of the access level register ACLR does not influence this operation since input IN is only relevant if there is a mark in the line “with key”. During storage, the picture is encrypted. For this purpose a so-called public key KPUB of the user is used. This key KPUB can be stored in the portable storage device MC as it is not secret. If the portable storage device MC is shared by a couple of users, the portable storage device MC should store separate public keys KPUB for each user. It is also imaginable that the public key KPUB is provided from the host device DEV or the transponder T or the mobile device MOB. It is even possible that encryption is provided by the host device DEV, so that data DAT does not need further processing within the storage device MC.

Now the user takes the storage device MC out of the host device DEV again and attempts to transfer the picture to his computer (not shown). Therefore he puts the portable storage device MC into a designated slot of the computer and brings his mobile device MOB into the vicinity of the storage device MC. The storage device MC is powered through the electric connection to the computer and broadcasts a request Q for transmitting a key K. Subsequently, the mobile device MOB transmits key K to the storage device MC where it is compared to a predefined value V again. Because the result of the check is true, switch SW is activated thus connecting memory MEM and interface INT. Furthermore, a second key is transmitted to the portable storage device MC which is meant for decrypting data DAT. It is possible for the same key to be used but for security reasons it is preferred to use two different keys. This second key is a so-called private key KPRIV which is secret and shall not get into the hands of unauthorized persons. With this private key KPRIV and decrypting means DEC data DAT is decrypted and transmitted to the computer where it can be looked at and stored.

The aforesaid example illustrates only one possible embodiment. So it is also imaginable that a transponder T with input means is used instead of the mobile device MOB. It is also possible that transponder T has no input means but an access level is set with help of the host device DEV. Anyway, this should only be possible if key K is present. Otherwise portable storage device DEV is more or less insecure.

It is easy to apply the inventive idea to other cases of use. So it is possible to securely transfer data DAT from one computer to another computer through an inventive USB-stick. It is also possible that one USB-stick is shared by a couple of users. Therefore, key K may also serve to identify a user and to set corresponding access rights. It is further imaginable that each user has his own private key KPRIV, so that each user can only decrypt his own data. Furthermore it is possible that one transponder T or one mobile device MOB per user serves for more portable storage devices MC, so that the system is easier to use. A further increase of ease of use is provided when a transponder T or a mobile device MOB serves a couple of applications. For instance a keycard for a car which is necessary to start the engine can also unlock the inventive storage device MC.

It is also imaginable that transponder T or mobile device MOB is attached to further security devices such as a finger print sensor. In this example key K is only transmitted if a proper finger is put on the sensor. A similar solution would be input means for inputting a personal identification number, short PIN. Attaching additional security devices to the transponder T or mobile device MOB instead of attaching them to the storage device MC has the advantage that this solution also works well if the storage device MC slips in a host device DEV so that a finger print sensor could not be accessed. A similar example is a USB-stick which has often to be put into a socket on the rear of the PC. Scanning fingerprints is very uncomfortable in this case.

Examples of the parts of the systems shown in the figures are given only for better understanding. Transponder T can be a smart card, the portable storage device MC can be a microdrive and the host device DEV a digital camera. Furthermore, portable storage device MC can be a memory card and the host device DEV an MP3-player. Lastly it is imaginable that portable storage device MC is a USB-stick and the host device DEV is a PC. So it is easy to understand that data DAT can be pictures, pieces of music, videos, text files or even executable programs. It is also noted that a mobile device MOB such as a mobile phone or a PDA is not limited to serve as the provider for the key K but can also be used as a host device DEV. An example would be a PDA where a portable storage device MC is used to backup internal data or to provide additional functionality in the form of programs from external providers.

At this point it is also noted that the features of the invention which features appear alone or in combination can also be combined or separated, so that the great number of variations and use cases of the invention can easily be imagined.

1. Portable storage device (MC) comprising:
a memory (MEM) for storing data (DAT),
a data interface (INT) comprising electric contacts for exchanging data (DAT) between the memory (MEM) and a host device (DEV) via electric signals,
a radio communication interface (RI) designed for receiving a key (K),
checking means (COMP) for checking if a key (K) has a predefined value (V), and
access inhibit means (SW) for controlling access to the memory (MEM), wherein the access inhibit means (SW) are controlled by the checking means (COMP).

2. Portable storage device (MC) as claimed in claim 1, further comprising:
encrypting means (ENC) for encrypting data (DAT) which is transferred from host device (DEV) to memory (MEM), and
decrypting means (DEC) for decrypting data (DAT) which is transferred from memory (MEM) to host device (DEV).

3. Portable storage device (MC) as claimed in claim 1, characterized in that data interface (INT) is omitted and said radio communication interface (RI) is additionally arranged for exchanging data (DAT) between memory (MEM) and the host device (DEV) via radio instead.

4. Portable storage device (MC) as claimed in claim 1, characterized in that memory (MEM), radio communication interface (RI), checking means (COMP), access inhibit means (SW) as well as the optional data interface (INT) are included in a single chip.

5. Portable storage device (MC) as claim in claim 1, characterized in that radio communication interface (RI) or data interface (INT) is arranged for receiving an access level which is to define different access rights for different access operations to memory (MEM), and/or to define different access rights for different parts of memory (MEM) wherein said portable storage device (MC) furthermore comprises means for storing said access level (ACLR).

6. Portable storage device (MC) as claimed in claim 5, characterized in that it furthermore comprises means to set said access level.

7. Method for exchanging data (DAT) between a memory (MEM) of a portable storage device (MC) and a host device (DEV), the method comprising the steps of:
connecting the portable storage device (MC) with the host device (DEV) via electric contacts or a radio link, and
permitting access to the memory (MEM) through said electric contacts or said radio link if a predefined key (K) can be received from a transponder (T) or a mobile device (MOB).

8. Method as claimed in claim 7, wherein data (DAT) which is transferred from host device (DEV) to memory (MEM) is encrypted and data (DAT) which is transferred from memory (MEM) to host device (DEV) is decrypted.

9. Method as claimed in claim 7, characterized in that access is permitted until portable storage device (MC) is disconnected from the host device (DEV) once the key (K) has been transmitted.

10. Method as claimed in claim 7, characterized in that access for a running operation between host device (DEV) and portable storage device (MC) is permitted until said operation has been finished.

11. Method as claimed in claim 7, characterized in that an access level for at least a part of the memory (MEM) is received by the portable storage device (MC) over a radio communication interface (RI) or over an electric data interface (INT) and stored in said portable storage device (MC).

12. Transponder (T),
having means for inputting an access level which access level is to define different access rights for different access operations to a memory (MEM) of a portable storage device (MC) and/or to define different access rights for different parts of a memory (MEM) of a portable storage device (MC), wherein said portable storage device (MC) is designed for exchanging data (DAT) with a host device (DEV) and
having means for transmitting said access level to said portable storage device (MC) via a radio link.

13. Mobile device (MOB),
having means for inputting an access level, which access level is to define different access rights for different access operations to a memory (MEM) of a portable storage device (MC) and/or to define different access rights for different parts of a memory (MEM) of a portable storage device (MC), wherein said portable storage device (MC) is designed for exchanging data (DAT) with a host device (DEV) and
having means for transmitting said access level to said portable storage device (MC) via electric contacts or a radio link.

14. Digital camera,
having means for inputting an access level, which access level is to define different access rights for different access operations to a memory (MEM) of a portable storage device (MC) and/or to define different access rights for different parts of a memory (MEM) of a portable storage device (MC), wherein said portable storage device (MC) is designed for exchanging data (DAT) with a host device (DEV) and
having means for transmitting said access level to said portable storage device (MC) via electric contacts or a radio link.
